(19) United States
(12) Patent Application Publication
(10) Pub. No.: US 2026/0085135 A1
(43) Pub. Date: Mar. 26, 2026

(54) CLEAVABLE FREE-RADICAL CURABLE COMPOSITION

(71) Applicant: ALLNEX BELGIUM S.A., Drogenbos (BE)

(72) Inventors: Hugues VAN DEN BERGEN, Drogenbos (BE); Patrice ROOSE, Sint Pieters Leeuw (BE); Florian LUNZER, Brussels (BE); Richard Hendrikus Gerrit BRINKHUIS, ZWOLLE (NL)

(73) Assignee: ALLNEX BELGIUM S.A., Drogenbos (BE)

(21) Appl. No.: 19/109,793

(22) PCT Filed: Sep. 7, 2023
(86) PCT No.: PCT/EP2023/074642

§ 371 Date: Mar. 7, 2025

(30) Foreign Application Priority Data
Sep. 9, 2022 (EP) 22194741.9

(51) Int. Cl. C08F 22/10; C08J 5/24; C08J 11/26

(52) U.S. Cl. CPC C08F 22/1006; C08J 5/244; C08J 11/26; C08F 2810/20; C08J 2335/02

(57) ABSTRACT

A composite comprising a filler and a free-radical curable composition that is cleavable after being cured, comprising at least one crosslinker molecule component a. of general formula E¹-O—C(R²)(R³)—X-E² (1), wherein each of E¹ and E² comprises an ethylenically unsaturated free-radical polymerizable moiety, X is either oxygen (O) or sulphur (S), and optionally, at least one ethylenically unsaturated free-radical polymerizable molecule component b, not comprising the moiety —O—C(R²)(R³)—X—, wherein in case the composition is cured, the composition forms a polymer having a T_{g} of more than 50° C. as measured by dynamic mechanical thermal analysis (DMTA).

### FIELD OF THE INVENTION

The present invention relates to a composite comprising a filler and a cured free-radical curable composition which is cleavable. The present invention further relates to a method for at least partially cleaving the composite to at least partially recover the filler.

### BACKGROUND OF THE INVENTION

In the area of composite materials recovery and recycling of expensive reinforcing filler material such as glass and carbon fibers and/or of the resin have become a priority in the context of sustainability and circular economy.

In conjunction with photo- or electron beam initiation, free-radical curable resins are used in the production of glass fiber and carbon fiber composites. While cured composites based on free-radical polymerizable groups have excellent mechanical and chemical resistance due to their tightly crosslinked network, recycling remains a challenge. De-crosslinking of thermoset resins such as radiation cured resins, or recycling of the filler materials in composites is significantly more difficult compared to composites made of thermoplastic materials owing to the high crosslinking density of the first.

WO2015/164087 describes a radiation curable composition comprising a polymer made from cleavable crosslinking polymers for use in pressure sensitive adhesives (PSA) whereby the cured composition has a low glass transition temperature (T_{g}). The goal is to tune the physical properties of the PSA such as the gel content, the storage modulus or peel adhesion, upon actinic or heat activation of the cleavable moieties in order to achieve a range of PSA application performances

There is a need in the art for free-radical curable compositions which can be used in composite, having a good recyclability at the end of their life while maintaining an excellent integrity during their lifetime.

### SUMMARY

It is hence an object of the present invention to develop a composite comprising a cured free-radical curable composition enabling good recyclability of the fibers in contact with such composition.

The composites of the present invention may have one or more of the following advantages:

They may have cured compositions that are cleavable or even dissolvable in specific environments, and hence, be incorporated in circular economy processes.

They may have cured compositions that are cleavable or even dissolvable in specific acid conditions, even without the addition of organic solvents.

They may have cured compositions that have excellent mechanical and chemical resistance in service life.

In a first aspect, the present invention relates to a composite comprising fillers and a cured free-radical curable composition that is cleavable wherein the uncured free-radical curable composition comprises the following components:
a. at least one crosslinker molecule component a. of general formula

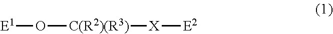

wherein each of E¹ and E² comprises an ethylenically unsaturated free-radical polymerizable moiety, X is either oxygen (O) or sulphur (S), and R² and R³ are independently selected from the list consisting of hydrogen, alkyl, alkenyl, alkynyl, cycloalkyl, cycloalkenyl, cycloalkynyl, aryl, heterocycloalkyl, heterocycloalkenyl, heteroaryl, alkoxyaryl, and alkoxy alkyl, or wherein C(R²)(R³) is linked to form a cycloalkyl, cycloalkenyl, cycloalkynyl, aryl, heterocycloalkyl, heterocycloalkenyl, heteroaryl or alkoxyaryl ring structure, and wherein R² and R³ independently, or in case C(R²)(R³) forms a ring structure are either substituted or not,
b. optionally, at least one ethylenically unsaturated free-radical polymerizable molecule component b., not comprising the moiety —O—C(R²)(R³)—X—,
   where the cured material formed after polymerization of the composition has a glass transition temperature (T_{g}) higher than 50° C. as measured by dynamic mechanical thermal analysis (DMTA), and wherein the filler is an organic or inorganic fiber.

In a second aspect, the present invention relates to a method for at least partially recycling the filler and optionally the cleaved cured free-radical curable composition of the composite according to any embodiment of the first aspect, comprising subjecting the cured free-radical curable composition to a cleaving environment comprising at least one of: —an aqueous liquid, —an alcohol, —an acid, and—a temperature above 40° C., preferably above 85° C. degrees.

### DETAILED DESCRIPTION OF THE INVENTION

As used herein and unless provided otherwise, the term “cleavable” means that the composition undergoes a breaking of a covalent bound in a cleaving environment. In this context, a specific form of cleavable is “dissolvable”. The term “cleaving environment” relates to an environment comprising at least one of: —an aqueous liquid, —an alcohol, —an acid, and a temperature above 40° C., preferably above 60° C., more preferably above 85° C. The term “dissolvable” as used herein means that the composition undergoes a breaking of a covalent bound in a “cleaving environment” which is a liquid comprising at least one of: —an aqueous liquid, —an alcohol, —an acid, possibly in combination with a higher temperature, whereby the composition is at least partially dissolved in the liquid. Preferably, if the cleaving environment comprises an aqueous liquid, an acid is also present. Preferably, the pH of the aqueous liquid is below 5, preferably below 4, more preferably below 3. For instance, it can be from 1.5 to 2.5 or from 1.8 to 2.2. Preferably, the temperature is not raised beyond 300° C. This is to avoid thermal degradation of the cured free-radical curable composition.

In a first aspect, the present invention relates to a composite comprising fillers and a cured free-radical curable composition that is cleavable, wherein the uncured free-radical curable composition comprises the following components:
a. at least one crosslinker molecule component a. of general formula

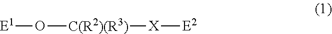

wherein each of E¹ and E² comprises an ethylenically unsaturated free-radical polymerizable moiety, X is either oxygen (O) or a sulphur (S), and R² and R³ are independently selected from the list consisting of hydrogen, alkyl, alkenyl, alkynyl, cycloalkyl, cycloalkenyl, cycloalkynyl, aryl, heterocycloalkyl, heterocycloalkenyl, heteroaryl, alkoxyaryl, and alkoxy alkyl, or wherein C(R²)(R³) is linked to form a cycloalkyl, cycloalkenyl, cycloalkynyl, aryl, heterocycloalkyl, heterocycloalkenyl, heteroaryl or alkoxyaryl ring structure, and wherein R² and R³, independently, or in case C(R²)(R³) forms a ring structure are either substituted or not,
b. optionally, at least one ethylenically unsaturated free-radical polymerizable molecule component b., not comprising the moiety —O—C(R²)(R³)—X—,
   where the cured free-radical curable composition material formed after polymerization of the composition has a glass transition temperature (T_{g}) higher than 50° C., as measured by dynamic mechanical thermal analysis, and wherein the filler is an organic or inorganic fiber.

For clarity, all values cited for the glass transition temperatures (T_{g}) refer to the state after polymerization (i.e., curing) of the neat cured free-radical curable composition, meaning without filler, as determined by dynamic mechanical thermal analysis (abbreviated as DMTA) unless stated otherwise.

According to this invention, fillers are organic or inorganic fibers. Synthetic fibers can be organic or inorganic. Examples of synthetic inorganic fibers are glass fibers and boron fibers. Examples of organic synthetic fibers are carbon fibers, polyamide (polyaramid) fibers. Examples organic natural fibers (or biofibers) are plant-derived fibers (from wood, sisal, hemp, coconut, cotton, kenaf, flax. Preferably, the fibers are selected from glass fibers and/or carbon fibers. The composite of the first aspect is formed by curing the cured free-radical curable composition contact with the filler. The fibers are used as reinforcement in the cured radically curable composition.

The uncured free radical curable composition of the first aspect is curable by the action of free-radicals by virtue of compounds a. and b. being polymerizable by the action of free-radicals. For instance, free-radical curing can be initiated by an electron beam, by the combination of a photoinitiator and actinic radiation such as ultra-violet radiation in the wavelength range from 200 to 400 nm or the visible light range with wavelengths from 400 to 550 nm, or following the thermal decomposition of a radical initiator such as a peroxide or an azo compound.

Preferably, at least one component a. and optionally b. results in a cured material with a T_{g} value higher than 50° C. Component b., if present, is preferably present in the composition in an amount such that, after curing, the overall composition forms a material having a T_{g} higher than 50° C.

Preferably, component b, when polymerized, has a T_{g} value exceeding 10° C.

The composition of the first aspect is preferably liquid at 25° C. For resin infusion composite applications, preferably, it has a viscosity below 5000 mPa·s at 25° C. For instance, it may have a viscosity below 2500 mPa·s at 25° C. or below 1000 mPa·s at 25° C. A viscosity of below 1000 mPa·s at 25° C. is advantageous for using the composition in the manufacturing of a composite material by resin infusion. Some embodiments of the present invention also provide viscosities in the range 1 to 50 mPa·s at 25° C.

Viscosities are measured according to DIN EN ISO 3219 using a rotational rheometer at a shear rate of 20 s⁻¹.

The glass transition temperature (T_{g}) marks the boundary between the glassy, rigid state and the softer relaxed state of a polymer or polymer network which can be rubbery or even fluid. A suitable method for the determination of the glass transition temperature of solid polymers or polymer networks is dynamical mechanical thermal analysis as for instance described by the standard method ASTM D4065-01 (Standard test method for the assignment of the glass transition temperature by Dynamic Mechanical Analysis).

Preferably, the T_{g} of the cured free-radical curable composition may be more than 60° C., yet more preferably more than 75° C. Typically, it is lower than 160° C., such as lower than 140° C.

After curing the free-radical curable composition should fulfill requirements in terms of mechanical properties for application in the composite. Young's modulus or tensile modulus of elasticity is a mechanical property that provides an index for the degree of stiffness of a solid material. It defines the relationship between tensile stress (force per unit area) and tensile strain (relative deformation) of a material for small uniaxial deformation. The ultimate tensile elongation (UTE) or elongation at break describes the resistance of the material against failure. Tensile properties are reported at a temperature of 23° C. according to one of the following standard methods for the determination of tensile properties, ASTM D638 (Standard Test Method for Tensile Properties of Plastics), ASTM D882 (Standard Test Method for Tensile Properties of Thin Plastic Sheeting) or ISO527-1 (Plastics—Determination of tensile properties). These measurements are made for the neat cured free radical curable compositions, i.e. without the presence of the filler.

In embodiments, the cured free-radical curable composition may have a Young's modulus of at least 10 Mpa, preferably at least 100 Mpa, more preferably at least 1000, or 3000 Mpa.

In embodiments, the cured free-radical curable composition may have a UTE of at least 0.2%, preferably at least 0.5%, and more preferably at least 2.0%. For instance, it may have an UTE from 3 to 15% which is particularly advantageous when the composition is used with a filler such as glass or carbon fibers.

In addition to components a. and b., the composition may comprise further components.

For instance, it may comprise a component c. which is at least one ethylenically unsaturated free-radical polymerizable molecule not comprising the moiety —O—C(R²)(R³)—X—, having a T_{g} of 10° C. or less upon polymerization. It may be present in the composition in an amount such that, after curing, the overall composition has a T_{g} exceeding 50° C. When present, component c. is preferably present in an amount less than 5 wt. % of the sum of components a., b., and c. Preferably, no component c. is present.

In another embodiment, the composition may comprise a solvent (component d.). The solvent d. may be present in any amount because it will be removed before or during curing of the composition.

It may also comprise a radical photoinitiator or a radical thermal initiator (component e.).

In the crosslinker molecule component a. of general formula E¹-O—C(R²)(R³)—X-E², R² and R³ are preferably independently selected from the list consisting of hydrogen, alkyl (e.g., C₁-C₆), and aryl, or are linked together to form a 5 or a 6 carbons ring structure. On a preferred embodiment, R² and R³ are independently selected from the list consisting of hydrogen, and methyl, or are linked such that C(R²)(R³) forms a 5-carbon ring structure.

R² and R³ are preferably both alkyl groups. Most preferably, none of R² and R³ is hydrogen, because upon hydrolysis after cleaving, formaldehyde or other aldehydes, like acetaldehyde will produced, which not is not preferred for environmental reasons. In preferred embodiments, X is an oxygen atom.

Each crosslinker molecule, by virtue of the presence of E¹ and E², is capable of acting as a crosslinker. E¹ and E² can independently be any moiety comprising one or more ethylenically unsaturated free-radical polymerizable functional group. E¹ and E² can be the same or can be different. When they are the same it is advantageous because it is easier to manufacture. It is, however, not obligatory. In embodiments, E¹ and E² may each comprise a functional group independently selected from a vinyl (e.g., a vinyl ether), an acrylamide, a methacrylamide, an acrylate functional group, or a methacrylate functional group. Preferably, E¹ and E² may each comprise an acryloyl functional group, or a methacryloyl functional group. For instance, E¹ and E² may each independently comprise or form a methacrylate or acrylate functional group.

When component a. comprises a crosslinker molecule wherein E1 and/or E2 comprise more than one ethylenically unsaturated free-radical polymerizable functional group, the amount of this crosslinker is preferably at most 20 wt. % of the crosslinkers making up component a.

In embodiments, E¹ and E² may independently be selected from the formulas:

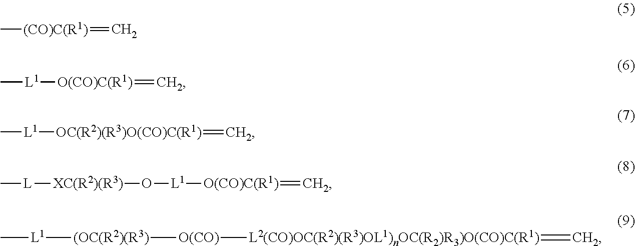

wherein X, R² and R³ are as previously described for formula (1) but are selected independently therefrom. Preferably, X, R², and R³ are the same as the X, R², and R³ present in formula (1),
wherein L², L¹ and L are divalent linking groups that can be the same or different, and are selected independently of one another with the proviso that L² can be a single bond, and
wherein R¹ is either H or CH₃ but is preferably CH₃ to obtain a cured composition having a higher T_{g}.

The divalent linking groups, L², L¹ and L, typically have a molecular weight less than 2000 g/mol. In some embodiments, the molecular weight is less than 500, 250, 100, 75 or 50 g/mol.

In some preferred embodiments, the divalent linking groups L², L¹ or L may be an (e.g., C₁-C₆) alkylene groups. In some embodiments, L², L¹ or L is a C₂, C₃, or C₄ alkylene group.

In some embodiments, L² may be a single bond.

In some embodiments, the divalent linking group L¹ may comprise an oligomer. For instance, L¹ may have the formula

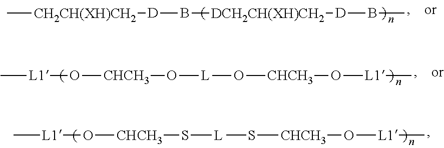

wherein L and L^{1′} are different from L¹ and wherein L^{1′} is a divalent linking moiety as defined above for L but selected independently thereof,
wherein B can be selected from alkylene, alkenylene, alkynylene, arylene, alkylene-arylene, arylene-alkylene, alkylene-arylene-alkylene, alkenylene-arylene, arylene-alkenylene, alkenylene-arylene-alkenylene, alkylene-arylene-alkenylene, alkenylene-arylene-alkylene, alkynylene-arylene, arylene-alkynylene, alkynylene-arylene-alkynylene, alkynylene-arylene-alkylene, alkylene-arylene-alkynylene, alkenylene-arylene-alkynylene, alkynylene-arylene-alkenylene, heteroarylene, alkylene-heteroarylene, heteroarylene-alkylene, alkylene-heteroarylene-alkylene, alkenylene-heteroarylene, heteroarylene-alkenylene, alkenylene-heteroarylene-alkenylene, alkylene-heteroarylene-alkenylene, alkenylene-heteroarylene-alkylene, alkynylene-heteroarylene, heteroarylene-alkynylene, alkynylene-heteroarylene-alkynylene, alkynylene-heteroarylene-alkylene, alkylene-heteroarylene-alkynylene, alkenylene-heteroarylene-alkynylene, alkynylene-heteroarylene-alkenylene, cycloalkylene, alkylene-cycloalkylene, cycloalkylene-alkylene, alkylene-cycloalkylene-alkylene, alkenylene-cycloalkylene, cycloalkylene-alkenylene, alkenylene-cycloalkylene-alkenylene, alkylene-cycloalkylene-alkenylene, alkenylene-cycloalkylene-alkylene, alkynylene-cycloalkylene, cycloalkylene-alkynylene, alkynylene-cycloalkylene-alkynylene, alkynylene-cycloalkylene-alkylene, alkylene-cycloalkylene-alkynylene, alkenylene-cycloalkylene-alkynylene, alkynylene-cycloalkylene-alkenylene, heterocycloalkylene, alkylene-heterocycloalkylene, heterocycloalkylene-alkylene, alkylene-heterocycloalkylene-alkylene, alkenylene-heterocycloalkylene, heterocycloalkylene-alkenylene, alkenylene-heterocycloalkylene-alkenylene, alkylene-heterocycloalkylene-alkenylene, alkenylene-heterocycloalkylene-alkylene, alkynylene-heterocycloalkylene, heterocycloalkylene-alkynylene, alkynylene-heterocycloalkylene-alkynylene, alkynylene-heterocycloalkylene-alkylene, alkylene-heterocycloalkylene-alkynylene, alkenylene-heterocycloalkylene-alkynylene, alkynylene-heterocycloalkylene-alkenylene, cycloalkenylene, alkylene-cycloalkenylene, cycloalkenylene-alkylene, alkylene-cycloalkenylene-alkylene, alkenylene-cycloalkenylene, cycloalkenylene-alkenylene, alkenylene-cycloalkenylene-alkenylene, alkylene-cycloalkenylene-alkenylene, alkenylene-cycloalkenylene-alkylene, alkynylene-cycloalkenylene, cycloalkenylene-alkynylene, alkynylene-cycloalkenylene-alkynylene, alkynylene-cycloalkenylene-alkylene, alkylene-cycloalkenylene-alkynylene, alkenylene-cycloalkenylene-alkynylene, alkynylene-cycloalkenylene-alkenylene, heterocycloalkenylene, alkylene-heterocycloalkenylene, heterocycloalkenylene-alkylene, alkylene-heterocycloalkenylene-alkylene, alkenylene-heterocycloalkenylene, heterocycloalkenylene-alkenylene, alkenylene-heterocycloalkenylene-alkenylene, alkylene-heterocycloalkenylene-alkenylene, alkenylene-heterocycloalkenylene-alkylene, alkynylene-heterocycloalkenylene, heterocycloalkenylene-alkynylene, alkynylene-heterocycloalkenylene-alkynylene, alkynylene-heterocycloalkenylene-alkylene, alkylene-heterocycloalkenylene-alkynylene, alkenylene-heterocycloalkenylene-alkynylene, alkynylene-heterocycloalkenylene-alkenylene.
B is preferably arylene-alkylene or cycloalkylene-alkylene. B is most preferably phenylene-methylene or cyclohexylene-methylene.
D and X are independently selected from O and S.
n is preferably from 1 to 10.

Especially preferred are embodiments wherein E1 and/or E2, more preferably E1 and E2 is -L¹-O(CO)C(R¹)═CH₂ (6).

In an embodiment, each or one or more of the at least one crosslinker molecule (component a.) may have a general formula selected from

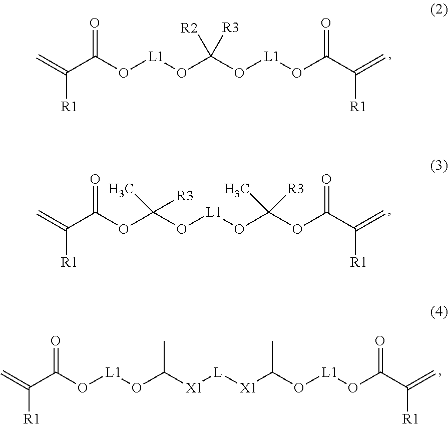

wherein X¹ is selected from O and C(O)O wherein the C is directly bonded to L;
wherein R¹, R², R³, L, and L¹ are as defined earlier.

Formula (2) corresponds to a preferred embodiments of formula (1) wherein E1 and E2 are both according to formula (6).

Formula (3) corresponds to embodiments of formula (1) wherein E1 is according to formula (5) and E2 is according to formula (7). This embodiment is less preferred.

Formula (4) corresponds to embodiments of formula (1) wherein E1 is according to formula (6) and E2 is according to formula (8). This embodiment is less preferred.

In embodiments, each or one or more of the at least one crosslinker molecule may have a general formula selected from:

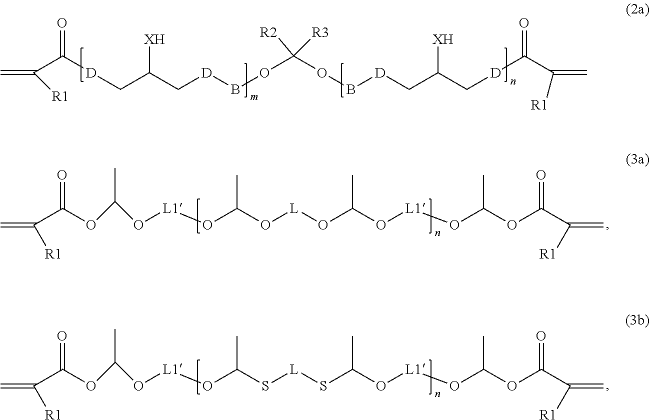

wherein L, D, B, X, R¹, R², and R³ are as defined above; L^{1′} is a divalent linking moiety as defined above for L but selected independently thereof, m is from 1 to 10; and n is from 1 to 10.

Crosslinkers according to formula (2) can, for instance, be synthesized as follows:

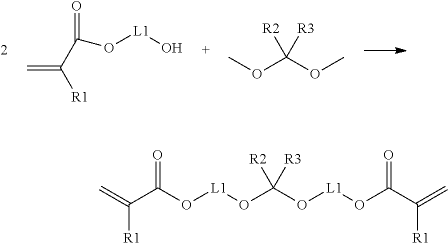

For example 2,2-di(2-acryloxyethoxy)propane can be synthesized from 2-hydroxyethylacrylate with dimethoxypropane as described in WO 2015/164087 A1 from 3M:

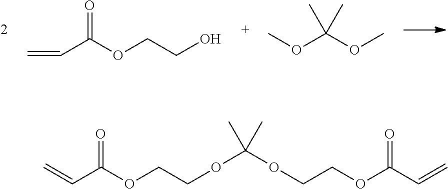

Alternatively the cleavable crosslinking monomer having a single —O—C(R²)(R³)—O— can be synthesized from ketone or aldehydes

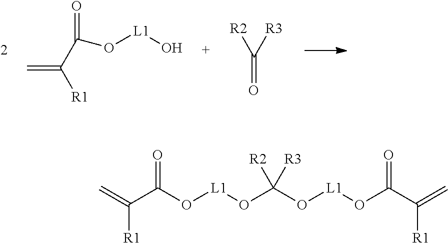

For example, 2,2-di(2-acryloxyethoxy)propane which can be synthesized from 2-hydroxyethylacrylate and acetone (R²═R³═CH₃):

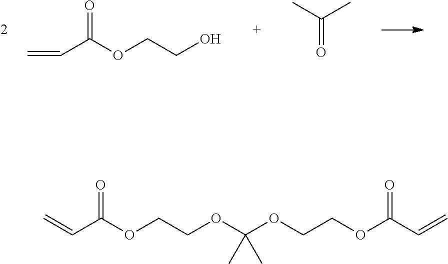

This synthesis can be achieved as follow: 2-hydroxyethylacrylate and acetone are dissolved in tetrahydrofuran at a molar ratio of 1:1:0.8, and 0.1 equivalent of p-toluenesulfonic acid pyridinium salt (PPTS) and an appropriate amount of 5 Å molecular sieve are added at room temperature. After 48 hours, the reaction mixture is neutralized with 0.1 equivalent of potassium carbonate. After filtration, the filtrate is evaporated to give 2,2-di(2-acryloxyethoxy)propane as a main product.

Similarly, 1,1-di(2-acryloxyethoxy)ethane can be synthesized from 2-hydroxyethylacrylate and acetaldehyde (R²=H, R³=CH₃) using similar reaction conditions as above:

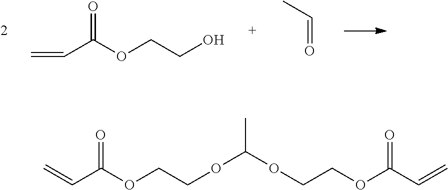

Similarly, 1,1-di(2-acryloxyethoxy)cyclopentane can be synthesized from 2-hydroxyethylacrylate and cyclopentanone (R² and R³=cyclopentane) using similar reaction conditions as above:

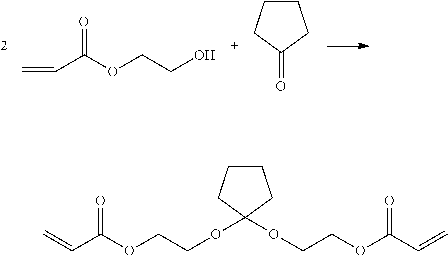

Examples of ketones are: acetone, methylethylketone, acetophenone, 2-pentanone, 3-methylbutanone (methylisopropylketone), 3-hexanone (ethylpropylketone),

Examples of cyclic ketone: cyclopentanone, cyclohexanone and their substituted analogues

Examples of aldehydes: formaldehyde, acetaldehyde, propionaldehyde, benzaldehyde

Crosslinkers according to formula (3) can, for instance, be synthesized as follow:

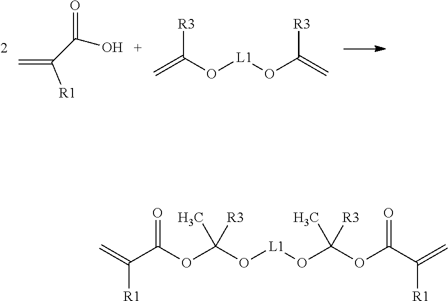

For example butane-1,4-diylbis(oxy)bis(ethane-1,1-diyl) diacrylate can be synthesized by the reaction of 1,4 divinylether with acrylic acid as described in WO 2015/164087 A1 from 3M (R¹=H; R³=H, L¹=(CH₂)₄).

Or as follows:

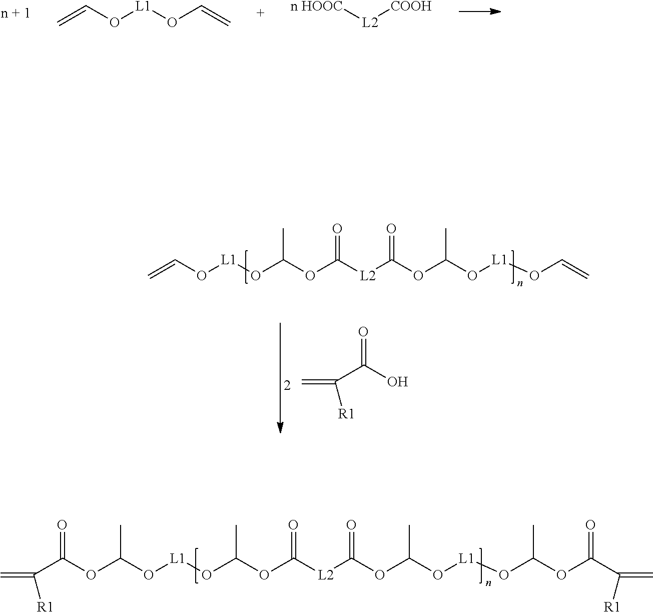

See example 11 and 12 for examples of crosslinker prepared this way.

Or as follows:

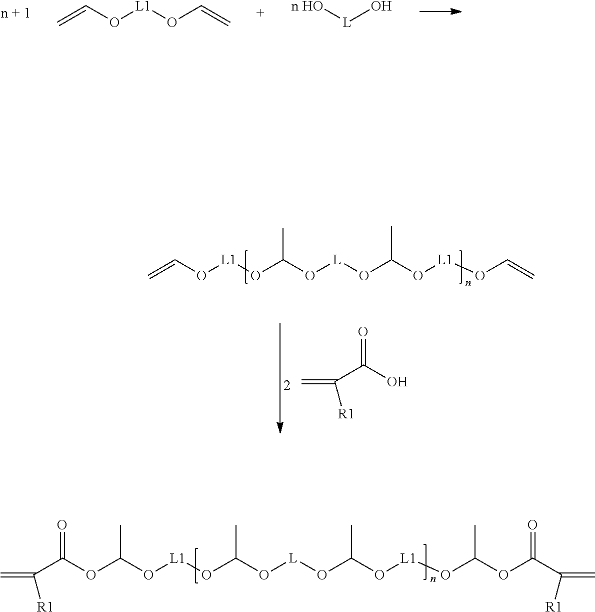

Wherein the reaction of the divinyl ether derivative and the diol can be performed in the presence of trifluoroacetic acid or a sulfonic acid.

Or as follows:

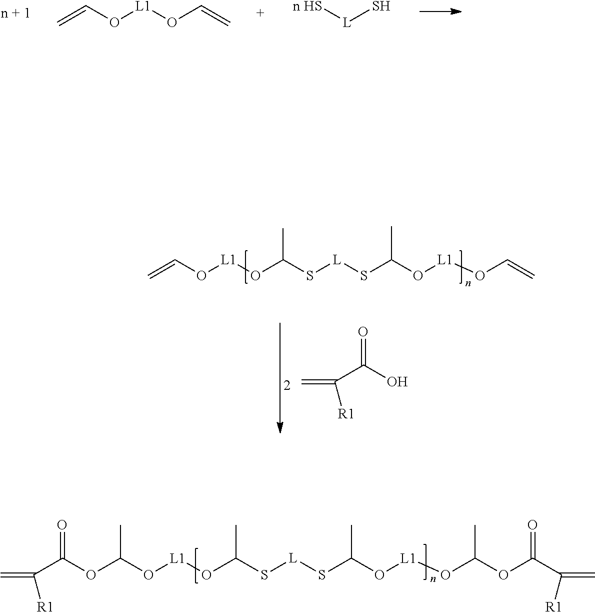

The reaction conditions are analogous to the one described in paper relating to addition of thiols to vinylethers for the synthesis of alkoxy thioethers described by Lou, Fengwen, et al.; Huaxue Xuebao (2010), 68 (12), 1223-1228.

Crosslinkers according to formula (4) can, for instance, be synthesized as follows:

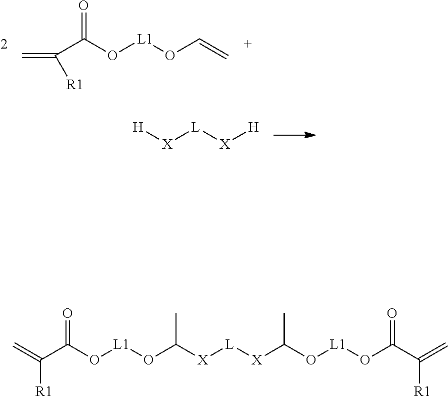

For example, 2-(2-vinyloxyethoxy)ethyl acrylate (R¹=H, L¹=CH₂CH₂OCH₂CH₂ is reacted with adipic acid (L=(CH₂)₄; X=COO) in a mol ratio of 2/1 using THF as solvent for 10 hours at 80° C. for 10 hours after which the solvent is evaporated.

Example of polycarboxylic acid of formula HOOCL²COOH are phthalic acid, isophthalic acid, terephthalic acid, oxalic acid, adipic acid, succinic acid, maleic acid, malonic acid, amongst others, and polyester having residual carboxylic groups.

Examples of polyols of formula HOLOH are ethyleneglycol, diethyleneglycol, tripropyleneglycol, 1,6-hexanediol, neopentylglycol, and cyclohexyldimethanol amongst others., polyethyleneglycol polypropyleneglycol and polyester having residual hydroxyl groups.

Examples of polythiols of formula HSLSH are poly(ethyleneglycol)dithiols including those with Mₙ from 500 to 10000 g/mol,

In embodiments, the T_{g} of the at least one crosslinker molecule component a. if polymerized together, may be more than 60° C., preferably more than 70° C., more preferably more than 80° C. In some embodiments, it is above 90° C., above 100° C. or even 110° C. or higher.

In embodiments, the amount of component a. is preferably higher than 5 wt. %, more preferably higher than 10 wt. %, even more preferably higher than 15 wt. %, yet more preferably higher than 30 wt. %, and most preferably higher than 50 wt. % of the sum of component a. and component b.

In embodiments, the amount of component a. is preferably lower than 99 wt. %, more preferably lower than 95 wt. % of the sum of component a. and component b.

The composition may further comprise component b., i.e., at least one ethylenically unsaturated free-radical polymerizable molecule, not comprising the moiety —O—C(R²)(R³)—X—. Preferably, component b. is present in the composition in an amount such that, after curing, the composition forms a polymer having a T_{g} of more than 50° C. Also, preferably at least one of component a. and component b. has a T_{g} when polymerized (i.e., if all molecules forming compound a. are polymerized or if all molecules forming compound b. are polymerized), higher than 50° C. as measured by DMTA. Due to the absence of the moiety —O—C(R²)(R³)—X—, component b. is typically not cleavable at the cleavable conditions where component a. is cleavable.

Said components b. are selected from monomers, oligomers, and polymers. As used herein, an oligomer comprises from 2 to 10 repeat units and a polymer comprises at least 11 repeat units as determined from the Mₙ as measured by gel permeation chromatography (GPC).

In embodiments, at least 95 wt. % of said components b. comprises at most two free-radical curable moieties, preferably one free-radical curable moiety. Up to 5 wt. % of said components b. may comprise three or more free-radical curable moieties. This typically still allows for a substantial change in the physical properties of the cured composition upon exposing it to a cleaving environment. In embodiments where a cured free-radical curable composition is in contact with a filler, such a change in physical properties can, for instance, be a complete dissolution, a partial dissolution, or any other change allowing an easier separation of the cured composition from the filler.

In embodiments, each of said components b. comprises at most two free-radical curable moieties. This favors a substantial change in the physical properties of the cured composition upon exposing it to a cleaving environment.

In preferred embodiments, each of said component b. comprises exactly one free-radical curable moiety. This particularly favors a substantial change in the physical properties of the cured composition upon exposing it to a cleaving environment.

Preferred free-radical curable moieties are selected from acrylate and methacrylate groups.

In embodiments, at least one of said component b. comprises a hydroxyl moiety. This is advantageous because OH moieties can promote adhesion to a substrate or a filler. It is particularly advantageous when the composition is cured in contact with glass fibers. Examples of such components b. are hydroxylalkyl (meth)acrylates such as 2-hydroxy ethyl (meth)acrylate; 2-hydroxy propyl (meth)acrylate; Tone™ M-100 (Dow Chemical) which is 2-hydroxy ethyl acrylate reacted with caprolactone; 2-hydroxy ethyl methacrylate reacted with caprolactone; 2-hydroxy ethyl (meth)acrylate reacted with ethylene oxide or with propylene oxide.

Preferably, each of said components b. has a T_{g} after polymerization of more than 10° C., preferably more than 20° C., preferably higher than 30° C., yet more preferably higher than 40° C., yet more preferably higher than 50° C.

For instance, the polymer of 2-hydroxyethylmethacrylate is characterized by a T_{g} value of 105° C. for the syndiotactic structure.

Preferably, component b. (which can consist in one or more ethylenically unsaturated free-radical polymerizable molecule, not comprising the moiety —O—C(R²)(R³)—X—, is present in the composition in an amount such that, after curing, the composition forms a polymer having a T_{g} of more than 50° C.

If component a. and b. independently result in a T_{g} higher than 50° C. after polymerization, any amount of component b. will satisfy the condition that the composition forms, after curing, a polymer with T_{g} value higher than 50° C. The amount of component b. can be at least 1 wt. %, preferably at least 5 wt. %, but can also be at least 30 wt % or even at least 50 wt % of the sum of component a. and component b.

In any other cases, the type of component b. and the suitable amounts of component b. can easily be determined either by trial and error or estimated using Fox equation,

$$\frac{1}{{T}_{g}} = Σ \frac{{w}_{i}}{{T}_{g i}} ,$$

from the T_{g} values of the polymerized constituent monomers (T_{gi}) and the respective weight fraction wᵢ.

In embodiments, this amount is preferably at least 1 wt %, preferably at least 5 wt. %, more preferably at least 30 wt %, or at least 50 wt % of the sum of component a. and component b.

In embodiments, the amount of component b. is preferably lower than 95 wt. %, more preferably lower than 90 wt. %, even more preferably lower than 85 wt. % and yet more preferably lower than 70 wt. %, of the sum of component a. and component b.

In one embodiment, the cured free-radical curable composition has a double bond conversion measured by infrared spectroscopy (e.g., the (meth)acrylate double bond conversion) from 20 to 100%, preferably from 70 to 100%. For tightly crosslinked polymer networks harsh cleavage conditions may be required in order to make the cured composition largely dissolvable or to obtain cleaved composition from which the filler can be removed. A person skilled in the art is able to find the right cleavage environment that is suitable for this purpose.

The cured free-radical curable composition has a T_{g} of higher than 50° C. Preferably, the T_{g} of the cured free-radical curable composition may be more than 60° C., preferably more than 70° C., yet more preferably more than 75° C. Typically, it is lower than 160° C., such as lower than 140° C.

In embodiments, the cured free-radical curable composition may have a Young's modulus of at least 10 MPa at 20° C.

To form the composite, the compounds a. and optional compound b. described in the first aspect can be contacted with the filler before curing.

The composite of the present invention can be used in automotive industry, aerospace industry, construction field, marine infrastructure, oil and gas industry, consumer goods, protective equipment, sports, and is in particularly suited in windblade (for a windturbine), for instance a windblade made of a composite material according to the first aspect.

In a second aspect, the present invention relates to a method for at least partially recycling the filler and optionally the cleaved cured free-radical curable composition of the composite comprising the filler in contact with the cured free-radical curable composition according to any embodiment of the first aspect, comprising the step of:
subjecting the composite to a cleaving environment comprising at least one of: —an aqueous liquid, —an alcohol, —an acid, and—a temperature above 40° C.

In one embodiment the method further comprises the step of recovering at least part of the filler and/or the cleaved cured free radical curable composition.

In a most preferred embodiment, the composite is subjected to a cleaving environment without the use of an organic solvent. This makes the recycling process cheaper and safer.

Preferably, the method for at least partially recycling the composite comprising the filler in contact with the cured free-radical curable composition according to any embodiment of the first aspect, comprises the step of:
subjecting composite to a cleaving environment consisting of an aqueous liquid, an acid and a temperature above 40° C.

Preferably the acid is acetic acid, preferably at a concentration above 15 wt % in water.

This allows recyclability of the cured free radical curable composition and of the filler because it degrades the cured free-radical curable composition, hence making it at least partly soluble, thereby separating the cured free-radical curable composition from the filler. When the composite comprises glass or carbon fibers, the glass or carbon fibers as well as the resin derivatives can be recovered by cleavage of the cured free radical curable composition.

Preferably, if the cleaving environment comprises an aqueous liquid, an acid is also present. Preferably, the pH of the aqueous liquid is below 5, preferably below 4, more preferably below 3. For instance, it can be from 1.5 to 2.5 or from 1.8 to 2.2.

Preferably, the soluble content after bringing the cured composition in a cleavable environment and in a suitable solvent, is at least 20 wt. %, more preferably at least 50 wt. %, even more preferably at least 90 wt. % or even 100 wt. %, whereby the soluble content is defined as the wt. % that is no longer part of the cured composition and is removed from the cured composition. A soluble content of 100 wt. % means that the composition completely falls apart or dissolves while as soluble content of 20 wt. % means that 20 wt. % of the original composition falls apart or dissolves. In some cases this can be already sufficient to separate the substrate or the filler. A higher temperature can accelerate this process.

In some embodiments, the cleavable environment is an increased temperature without the use of a solvent. In such environment the composition can be cleaved and is soluble once put in contact with a suitable solvent. It is also possible that by cleaving a solvent is generated, and no additional solvent is needed. In such conditions the soluble content is at least 20 wt. %, more preferably at least 50 wt. %, even more preferably at least 90 wt. % or even 100 wt. %, whereby the soluble content is defined as the wt. % that is no longer part of the cured composition and is removed from the cured composition once brought in contact with a suitable solvent. A soluble content of 100 wt. % means that the composition completely falls apart or dissolves while as soluble content of 20 wt. % means that 20 wt. % of the original composition falls apart or dissolves. In some cases this can be already sufficient to separate the substrate or the filler.

In this context a suitable solvent can be an aqueous liquid, or an organic solvent. Preferably an acid is added to the solvent.

Any feature of the second aspect can be as correspondingly described in any of the preceding aspects.

The present invention will now be described in details with reference to the following non-limiting examples which are by way of illustration only.

### EXAMPLES

### Determination of the Glass Transition Temperature (T_{g}) by Dynamic Mechanical Thermal Analysis (DMTA)

A suitable method for the determination of the glass transition temperature of solid polymers or cured polymer networks is dynamical mechanical thermal analysis as for instance described by the standard method ASTM D4065-01 (Standard test method for the assignment of the glass transition temperature by Dynamic Mechanical Analysis).

DMTA measurements are conducted using a DMA Q800 (TA Instruments) instrument in tensile mode. The dimensions of the samples between the clamps are typically 11 mm×8.0 mm×0.04 mm. A periodic strain deformation is applied with an amplitude of 30 μm at a frequency of 1 Hz. The viscoelastic properties are measured following a temperature profile increasing from −50 to 200° C. at a heating rate of 3° C. per minute. The T_{g} is determined as the temperature at the maximum of the loss factor curve (i.e. tan δₘₐₓ).

Determination of the (meth)acrylate Double Bound Conversion

A suitable instrumental technique for the determination of the conversion of ethylenic unsaturations (i.e. double bonds) for cured (meth)acrylate networks is ATR-FTIR (attenuated total reflection-Fourier transform infrared) spectroscopy. Procedures are conveniently described in ASTM E168 (Standard Practices for General Techniques of Infrared Quantitative Analysis) or equivalently ASTM E1252.

More specifically, the consumption of the (meth)acrylate double bonds was estimated from the area of the absorption peak at 1635 cm⁻¹ (stretching ν(C═C), area A₁₆₃₅) scaled with respect to the area of the absorption band of the carbonyl stretching at 1715 cm⁻¹ (ν(C═O), area A₁₇₁₅) in order to compensate for measurement fluctuations. The fractional double bond conversion was estimated by comparing the ratio A₁₆₃₅/A₁₇₁₅ of the cured and the initial liquid composition using

$$D BC ( \% ) = 100 [ 1 - {( {A}_{1635} / {A}_{1715} )}_{c u r e d} / {( {A}_{1635} / {A}_{1715} )}_{liquid} ]$$

### Example 1: Synthesis of Crosslinker G1

1 mol 1,4-bis(vinyloxy)butane was reacted with 2 mol of methacrylic acid to yield crosslinker G1 of formula (3) wherein L¹ is a butylene moiety, R¹ is methyl, and R³ is hydrogen.

### Example 2: Synthesis of Crosslinker G2

1 mol tripropyleneglycol divinylether was reacted with 2 mol methacrylic acid to yield crosslinker G2 of formula (3) wherein L¹ has for general formula —(—OCH₂CH(CH₃)—)₃—, R¹ is methyl, and R³ is hydrogen.

### Example 3: Synthesis of Crosslinker G3

Synthesis of 1,1-di(2-acryloxyethoxy)cyclopentane (R² & R³ Linked by Cyclopentane Ring).

2-hydroxyethylacrylate and cyclopentanone are dissolved in tetrahydrofuran at a molar ratio of 1:1:0.8, and 0.1 equivalent of p-toluenesulfonic acid pyridinium salt (PPTS) and an appropriate amount of 5 Å molecular sieve are added at room temperature. After 48 hours, the reaction mixture is neutralized with 0.1 equivalent of potassium carbonate. After filtration, the filtrate is evaporated to give 1,1-di(2-acryloxyethoxy)cyclopentane as a main product.

### Example 4: Preparation of Free-Radical Curable Composition F1

100 pbw of crosslinker G2 was mixed with 1 pbw of a photoinitiator (ADDITOL® BCPK). The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion of the cured composition was 80%. The T_{g} of the cured composition was 110° C.

### Example 5: Preparation of Free-Radical Curable Composition F2

50 pbw of crosslinker G1 was mixed with 50 pbw of 2-hydroxypropylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 80%. The T_{g} of the cured composition was 125° C.

### Comparative Example 1: Preparation of Free-Radical Curable Composition C1

50 pbw of 1,6-hexanedioldiacrylate was mixed with 50 pbw of 2-hydroxyethylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 82%. The T_{g} of the cured composition was 101° C.

### Comparative Example 2: Preparation of Free-Radical Curable Composition C2

50 pbw of 1,6-hexanedioldiacrylate was mixed with 50 pbw of 2-hydroxypropylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 80%. The T_{g} of the cured composition was 98° C.

### Example 6: Preparation of Free-Radical Curable Composition F3

50 pbw of crosslinker G2 was mixed with 50 pbw of 2-hydroxyethylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 72%. The T_{g} of the cured composition was 122° C.

### Example 7: Preparation of Free-Radical Curable Composition F4

50 pbw of crosslinker G2 was mixed with 50 pbw of 2-hydroxypropylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 73%. The T_{g} of the cured composition was 117° C.

### Example 8: Preparation of Free-Radical Curable Composition F5

50 pbw of crosslinker G2 was mixed with 25 pbw of 2-hydroxypropylmethacrylate and 25 pbw of isobornylmethacrylate. 1 pbw of a photoinitiator (ADDITOL® BCPK) was added to the mixture. The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion (DBC) of the cured composition was 72%. The T_{g} of the cured composition was 135° C.

### Example 9: Preparation of Free-Radical Curable Composition F6

100 pbw of crosslinker G1 was mixed with 1 pbw of a photoinitiator (ADDITOL® BCPK). The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion of the cured

### Composition was 80%. The T_{g} of the Cured Composition was 85° C.

### Example 10: Dissolution of Cured Samples in 30% Acetic Acid or 100% Acetic Acid

Cured compositions C1-C3 and F1-F6 were immersed in either 30% acetic acid or 100% acetic acid for one week at 80° C., followed by one week at room temperature. The table below indicates whether the cured composition was not dissolved (1), was partly dissolved (2), or was entirely dissolved (3) after two weeks. In general, partial dissolution allowed an easier separation of the cured composition from the substrate than when there was no dissolution at all. As can be seen for examples F5 and F1, the cleaving environment can be different depending on the composition. A person skilled in the art is able to find the right conditions.

| | 30% (w/v) acetic acid | 100% acetic acid |
|---|---|---|
| C1 | 1 | 1 |
| C2 | 1 | 1 |
| C3 | 1 | not tested |
| F2 | 2 | 3 |
| F3 | 2 | 3 |
| F4 | 2 | 3 |
| F5 | 1 | 3 |
| F6 | 3 | 1 |
| F1 | 3 | 1 |

### COMPARATIVE EXAMPLE 4: PREPARATION OF FREE-RADICAL CURABLE COMPOSITION C4

100 pbw of 2-hydroxypropylmethacrylate was mixed with 1 pbw of a photoinitiator (ADDITOL® BCPK). The resulting free-radical curable composition was coated on a glass substrate, covered with a polypropylene film, then UV-cured by exposure for 3 minutes to UV light (LED spot Hönle) at 14 cm from the substrate and delivering 110 mW cm⁻² at a wavelength of 365 nm. After polymerization, the (meth)acrylate double bond conversion of the cured composition was 100%. The T_{g} of the cured composition was 117° C.

### Example 11: Synthesis of Crosslinker G4

Reaction of triethyleneglycoldivinylether with adipic acid (HOOC—(CH₂)₄—COOH) followed by reaction with methacrylic acid; L¹=triethyleneglycol; L²=(CH₂)₄.

7.23 g of adipic acid and 29 g of 1,4-dioxane were added in a 50 ml glass reactor and heated at 80° C. under stirring. Then 20 g of triethyleneglycoldivinylether solubilized in 10 g of 1,4-dioxane were added. The reaction mixture was further heated for 14 hours at 80° C. after which the solvent was evaporated. The formation of acetal —O—CH(CH₃)—OC(═O)— linkages were clearly evidenced by the ¹H-NMR signals at 1.40 ppm (CH₃) and 5.94 ppm —O—CH(CH₃)—O—CO—. 10 g of the obtained product having residual vinylether groups was further reacted with 3 g of methacrylic acid and heated at 50° C. for 14 hours. Reaction of residual vinylether groups with methacrylic acid was confirmed by GPC analysis (peaks shift to higher molecular weights). The viscosity is 139 mPa s at 25° C.

### Example 12: Synthesis of Crosslinker G5

Reaction of 1,4-butanedioldivinylether with oxalic acid (HOOC—COOH) followed by reaction with methacrylic acid; L¹=(CH₂)₄; L²: single bond.

10 g of 1,4-butanedioldivinylether and 5 g of THF are added in a 50 ml glass reactor and stirred at room temperature; then 3.17 g of oxalic acid solubilized in 10 g THE are slowly added to the reactor and the reaction mixture is further stirred at room temperature for 7 hours after which the solvent is evaporated. The formation of the acetal —O—CH(CH₃)—OC(═O)— linkage was clearly evidenced by the ¹H-NMR signals at 1.50 ppm (CH₃) and 6.03 ppm O—CH(CH₃)—O—CO. Residual vinylether groups are reacted with one equivalent of (meth)acrylic acid.

### Example 13: Preparation of Glass Fiber Composites

A series of glass fiber composites has been prepared as follow.

50 pbw of glass fibers forming three layers and weighting 390 g per m² were infused with 50 pbw of resin mixed with 1 pbw of ADDITOL® HDMAP and 0.25 pbw of bis-acylphosphine oxide, two photoinitiators.

These infused fiber sheets were then cured as follow. Irradiation of both the top and the back side was performed by, for the top side, using two Ga lamps at a power density of 80 W/cm² at a conveyor speed of 10 m/min followed by irradiation with two Ga lamps at 120 W/cm² at a conveyor speed of 5 m/min; and for the back side, using two Ga lamps at 120 W/cm² at a conveyor speed of 5 m/min.

Composites comprising the following resins were prepared: 100% G1, 100% G2, 100% HEMA (2-hydroxyethylmethacrylate), 100% HPMA (2-hydroxypropylmethacrylate), and 100% Raylok C1100 (a styrene-free vinyl ester based resin specially developed for making glass fibre composites which are to be cured by Ultraviolet (UV) light).

### Example 14: Testing of Glass Fiber Composites

The composites of example 13 were cut to strips of 2×5 cm and introduced in containers for the test with 30% (w/v) acetic acid at 80° C. The results are shown in the table below:

| | Resin composition | 30% (w/v) acetic |
|---|---|---|
| | within the composite | acid 1 week at 80° C. |
| Invention | 100% G1 | Full fibers delamination |
| Invention | 100% G2 | Full fibers delamination |
| Comparative | 100% HEMA | No fibers delamination |
| Comparative | 100% HPMA | No fibers delamination |
| Comparative | 100% Raylok C1100 | No fibers delamination |

As can be observed, the fibers of the composites of the invention were completely separated from the resin after one week of treatment. This was not the case of the comparative examples.

### Example 15: Synthesis of Crosslinker G4

Synthesis of 2,2-di(2-methacryloxyethoxy)propane (ketal dimethacrylate) obtained from reacting 2-hydroxyethylmethacrylate with 2,2-dimethoxypropane following similar reaction conditions as described in preparatory example 1 of WO2015164087.

### Example 16: Preparation of Free-Radical Curable Composition F7

10 pbw of crosslinker G4 was mixed with 1 pbw of a photoinitiator (ADDITOL® BCPK) and 90 pbw of 2-hydroxypropyl methacrylate. Cured disks of 0.5 cm (diameter) and 1 mm thick of the resulting free-radical curable composition were made, using UV-curing by exposure for 3 minutes to UV light (LED spot Hönle) at 14 cm from the composition, protected by polypropylene film and delivering 110 mW cm⁻² at a wavelength of 365 nm. After polymerization, the methacrylate double bond conversion of the cured composition was more than 75%.

### Example 17: Testing of Glass Fiber Composites

The composite is prepared as described in example 13, using F7. The dissolution conditions are in 30 wt % acetic acid at 100° C. for 3 hours. The fibers of the composites could be easily delaminated.

1. A composite comprising fillers and a cured free-radical curable composition that is cleavable, wherein the uncured free radical curable composition comprises the following components:
at least one crosslinker molecule component a. of general formula E¹-O—C(R²)(R³)—X-E² (1), wherein each of E¹ and E² comprises an ethylenically unsaturated free-radical polymerizable moiety, X is either oxygen (O) or sulphur (S), and R², and R³ are independently selected from the list consisting of hydrogen, alkyl, alkenyl, alkynyl, cycloalkyl, cycloalkenyl, cycloalkynyl, aryl, heterocycloalkyl, heterocycloalkenyl, heteroaryl, alkoxyaryl, and alkoxy alkyl, or wherein C(R²)(R³) is linked to form a cycloalkyl, cycloalkenyl, cycloalkynyl, aryl, heterocycloalkyl, heterocycloalkenyl, heteroaryl or alkoxyaryl ring structure, and wherein R² and R³, independently, or in case C(R²)(R³) forms a ring structure are either substituted or not, and
optionally, at least one ethylenically unsaturated free-radical polymerizable molecule component b, not comprising the moiety —O—C(R²)(R³)—X—,
wherein in case the composition is cured, the composition forms a polymer having a T_{g} of more than 50° C. as measured by dynamic mechanical thermal analysis (DMTA), and wherein the filler is an organic or inorganic fiber.

2. The composite according to claim 1, wherein component b., when polymerized, has a T_{g} of more than 10° C. as measured by DMTA.

3. The composite according to claim 1, wherein component b. is present in an amount of at least 1 wt. %, preferably at least 5 wt. %, more preferably at least 30 wt % of the sum of component a. and component b.

4. The composite according to claim 1, wherein the concentration in said component b. is less than 95 wt. %.

5. The composite according to claim 1, wherein each of said components b. comprise one or two free-radical curable moieties.

6. The composite according to claim 1, wherein at least one of said components b. comprises an hydroxyl moiety.

7. The composite according to claim 1, wherein E1 and E2 each comprise either an acrylate moiety or a methacrylate moiety.

8. The composite according to claim 1, wherein one or more of the crosslinker molecules has a general formula selected from 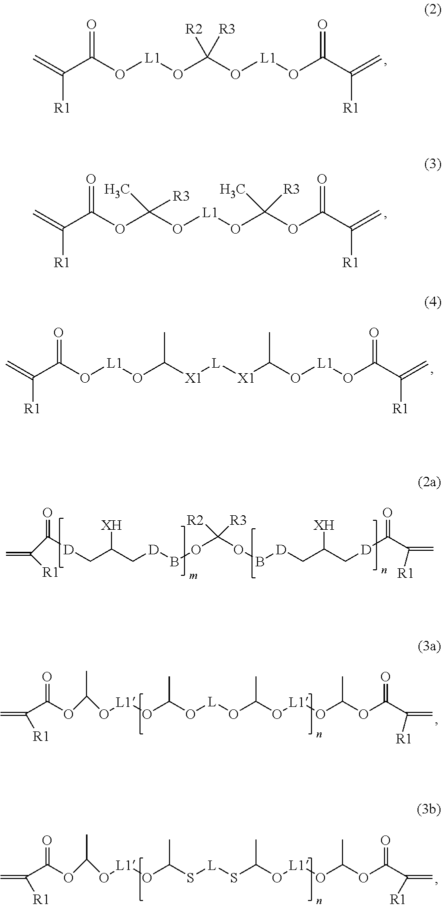
wherein X¹ is selected from O, C(O)O; wherein C is directly bonded to L; R¹ are independently selected from hydrogen and methyl; and L, L¹ and L^{1′} are independently selected from divalent linking moieties; D are independently selected from O; m is from 1 to 10; and n is from 1 to 10.

9. The composite according to claim 1, wherein the amount of component a. is above 5 wt. % of the sum of component a. and component b.

10. The composite according to claim 1, wherein the free radical curable composition has a viscosity below 1000 mPa·s at 25° C.

11. The composite according to claim 1, having a Young's modulus of at least 10 MPa at 20° C.

12. The composite according to claim 1, wherein the filler is selected from a glass fiber, carbon fibers and/or natural fibers.

13. A method for at least partially recycling the filler and optionally the cleaved cured free-radical curable composition of the composite according to claim 1, comprising the step of:
subjecting the cured free-radical curable composition to a cleaving environment comprising at least one of: —an aqueous liquid, —an alcohol, —an acid, and—a temperature above 40° C.

14. A method according to claim 13, further comprising the step of recovering at least part of the filler and/or the cleaved cured free-radical curable composition of the composite.
